(19) United States
(12) Patent Application Publication
(10) Pub. No.: US 2021/0095765 A1
(43) Pub. Date: Apr. 1, 2021

(54) HYDRAULIC MOTOR SHAFT SEAL ASSEMBLY

(71) Applicant: Lionel C. Long, Grand Rapids, OH (US)

(72) Inventor: Lionel C. Long, Grand Rapids, OH (US)

(21) Appl. No.: 17/032,088

(22) Filed: Sep. 25, 2020

Related U.S. Application Data
(60) Provisional application No. 62/906,811, filed on Sep. 27, 2019.

(51) Int. Cl. F16J 15/328

(52) U.S. Cl. CPC F16J 15/328

(57) ABSTRACT

A motor shaft seal assembly configured to prevent external elements from entering internal portions of a motor housing of a motor through a motor shaft seal is provided. The motor shaft seal assembly includes a seal plate configured to mount to a motor. The seal plate has a seal aperture configured to encircle a motor shaft of the motor. An inlet port is mounted to the seal plate. An internal passage extends from the inlet port, through the seal plate, to a plurality of annular cavities positioned proximate the motor shaft. A supply of a flexible sealing compound is provided to the plurality of annular cavities in a manner such as to contact the motor shaft, thereby forming an additional barrier to prevent external elements from entering internal portions of the motor through the motor shaft seal.

### RELATED APPLICATIONS

This application claims the benefit of pending U.S. Provisional Patent Application No. 62/906,811, filed Sep. 27, 2019, the disclosure of which is incorporated herein by reference in its entirety.

### BACKGROUND

Vehicles, such as the non-limiting example of salt trucks, commonly employ hydraulic motors for accomplishing routine operations. One such routine operation is distributing salt on the surfaces of roads through the rotation of a salt distributing spinner.

A hydraulic motor is a mechanical actuator that converts hydraulic pressure and flow into torque and angular displacement (rotation). In the example of a salt truck, the hydraulic motor is commonly used to rotate a salt distributing spinner used to propel salt from the salt truck to the roadway.

Typically, a hydraulic motor includes a housing configured to support a plurality of hydraulic ports. The hydraulic ports facilitate the inflow and outflow of hydraulic fluid. As the hydraulic fluid flows through the hydraulic motor, the hydraulic fluid engages an output shaft in a manner such as to produce rotation of the output shaft. The output shaft typically employs a shaft seal to prevent hydraulic fluid from exiting the housing and to prevent external elements from entering the internal portions of the housing. It is known that external elements within the housing can cause corrosion of the output shaft, which can lead to premature motor failure. In certain instances, the shaft seal can be insufficient to prevent external elements from entering the internal portions of the housing.

It would be advantageous to improve the sealing of the shafts of the hydraulic motors.

### SUMMARY

It should be appreciated that this Summary is provided to introduce a selection of concepts in a simplified form, the concepts being further described below in the Detailed Description. This Summary is not intended to identify key features or essential features of this disclosure, nor it is intended to limit the scope of the hydraulic motor shaft seal assembly.

The above objects as well as other objects not specifically enumerated are achieved by a motor shaft seal assembly configured to prevent external elements from entering internal portions of a motor housing of a motor through a motor shaft seal. The motor shaft seal assembly includes a seal plate configured to mount to a motor. The seal plate has a seal aperture configured to encircle a motor shaft of the motor. An inlet port is mounted to the seal plate. An internal passage extends from the inlet port, through the seal plate, to a plurality of annular cavities positioned proximate the motor shaft. A supply of a flexible sealing compound is provided to the plurality of annular cavities in a manner such as to contact the motor shaft, thereby forming an additional barrier to prevent external elements from entering internal portions of the motor through the motor shaft seal.

The above objects as well as other objects not specifically enumerated are achieved by a method of preventing external elements from entering internal portions of a motor housing of a motor through a motor shaft seal. The method including the steps of mounting a seal plate to a motor, the seal plate having a seal aperture configured to encircle a motor shaft of the motor, mounting an inlet port to the seal plate, forming an internal passage within the seal plate, extending the internal passage from the inlet port, through the seal plate, to a plurality of annular cavities positioned proximate the motor shaft and supplying a flexible sealing compound to the plurality of annular cavities in a manner such as to contact the motor shaft, thereby forming an additional barrier to prevent external elements from entering internal portions of the motor through the motor shaft seal.

Various objects and advantages of the hydraulic motor shaft seal assembly will become apparent to those skilled in the art from the following Detailed Description, when read in light of the accompanying drawings.

### BRIEF DESCRIPTION OF THE DRAWINGS

FIG. 1 is a perspective view of a portion of a conventional vehicle employing a conventional hydraulic motor to rotate a conventional salt-dispensing spinner.

FIG. 2 is a perspective view of the hydraulic motor and salt-dispensing spinner of FIG. 1.

FIG. 3 is a perspective view of the hydraulic motor of FIG. 1.

FIG. 4 is a front view of the hydraulic motor of FIG. 1.

FIG. 5 is a perspective view of the hydraulic motor of FIG. 3 fitted with a seal plate in accordance with the invention.

FIG. 6 is a plan view of the seal plate of FIG. 5.

FIG. 7 is a perspective view of a portion of the seal plate of FIG. 6 illustrating mounting fasteners used to attach the seal plate to the hydraulic motor of FIG. 3.

FIG. 8 is a perspective view of the assembled hydraulic motor of FIG. 3, the framework of FIG. 1 and the seal plate of FIG. 5.

FIG. 9 is a perspective view of an auxiliary shaft seal.

FIG. 10 is a cross-sectional view of a hydraulic motor shaft seal assembly assembled with the hydraulic motor and salt-dispensing spinner of FIG. 1, in accordance with the invention.

FIG. 11 is a cross-sectional view of a portion of the hydraulic motor shaft seal assembly of FIG. 10 assembled with the hydraulic motor and salt-dispensing spinner of FIG. 1.

FIG. 12 is a plan view of a second embodiment of the seal plate of FIG. 5.

FIG. 13 is a cross-sectional view of a hydraulic motor shaft seal assembly incorporating the second embodiment of the seal plate of FIG. 12, assembled with the hydraulic motor and salt-dispensing spinner of FIG. 1, in accordance with the invention.

### DETAILED DESCRIPTION

The hydraulic motor shaft seal assembly will now be described with occasional reference to specific embodiments. The hydraulic motor shaft seal assembly may, however, be embodied in different forms and should not be construed as limited to the embodiments set forth herein. Rather, these embodiments are provided so that this disclosure will be thorough and complete, and will fully convey the scope of the hydraulic motor shaft seal assembly to those skilled in the art.

Unless otherwise defined, all technical and scientific terms used herein have the same meaning as commonly understood by one of ordinary skill in the art to which the hydraulic motor shaft seal assembly belongs. The terminology used in the description of the hydraulic motor shaft seal assembly herein is for describing particular embodiments only and is not intended to be limiting of the hydraulic motor shaft seal assembly. As used in the description of the hydraulic motor shaft seal assembly and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the hydraulic motor shaft seal assembly. Notwithstanding that the numerical ranges and parameters setting forth the broad scope of the hydraulic motor shaft seal assembly are approximations, the numerical values set forth in the specific examples are reported as precisely as possible. Any numerical values, however, inherently contain certain errors necessarily resulting from error found in their respective measurements.

In accordance with the illustrated embodiments, a hydraulic motor shaft seal assembly (hereafter “seal assembly”) is provided. Generally, the seal assembly includes a shaft seal that forms a plurality of annular cavities adjacent the motor shaft of a hydraulic motor. The plurality of annular cavities are filled with a pressurized, flexible sealing compound in a manner sufficient to assist a motor seal in preventing external elements from entering the internal portions of the hydraulic motor through the shaft seal.

It will be understood the term “hydraulic motor”, as used herein, is defined to mean any mechanical actuator that converts hydraulic pressure and flow into torque and angular displacement (rotation). The term “shaft” as used herein, is defined to mean any rotating machine element, usually circular in cross section, used to transmit power from one part to another. It will be understood the term “seal”, as used herein, is defined to mean any mechanism, structure or device configured to preventing leakage, contain pressure, or exclude contamination.

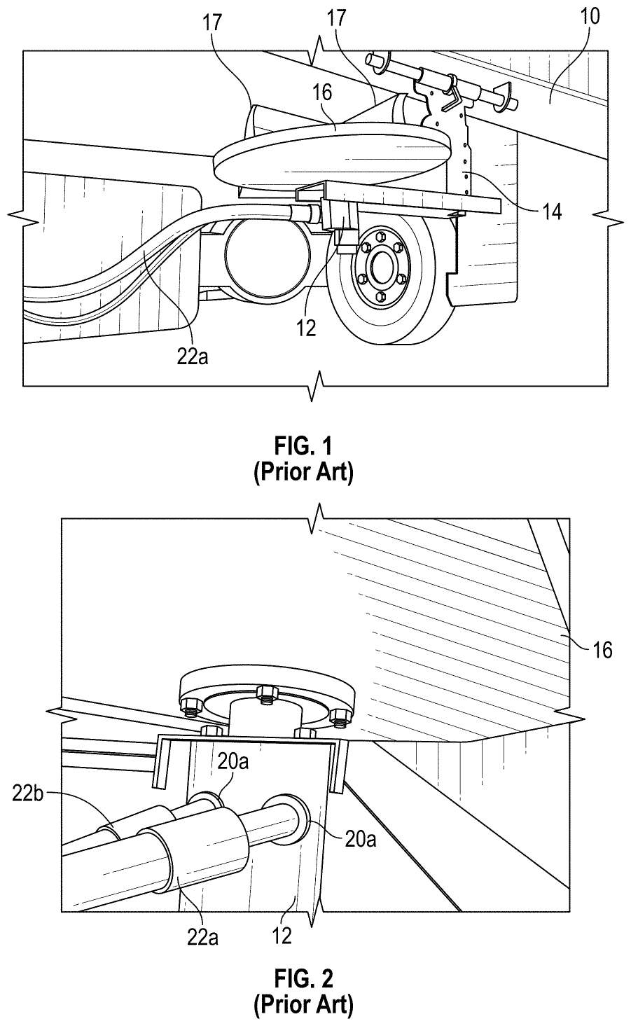

Referring now to the drawings, there is illustrated in FIG. 1 a rear portion of a vehicle 10 employing a hydraulic motor 12. In the illustrated embodiment, the vehicle 10 is a truck used to distribute salt onto a roadway. However, it should be appreciated that in other embodiments, the vehicle 10 can have other forms. The hydraulic motor 12 is supported by a framework 14 extending from the vehicle 10. In the illustrated embodiment, the framework 14 has the form of a U-shaped channel. In alternate embodiments, the framework 14 can have other forms sufficient to support the hydraulic motor 12.

Referring now to FIGS. 1 and 2, the hydraulic motor 12 is connected a spinner 16. The spinner 16 includes a plurality of vanes 17 extending from an upper surface. In operation, the hydraulic motor 12 urges rotation of the spinner 16. Rotation of the spinner 16 results in rotation of the plurality of vanes 17, which in turn, results in the distribution of salt falling onto the spinner 16 onto a roadway (not shown). In the illustrated embodiment, the hydraulic motor 12, spinner 16 and the plurality of vanes 17 are conventional in the art. The spinner 16 can have any desired structure sufficient to distribute salt. However, in other embodiments, the hydraulic motor 12, spinner 16 and the plurality of vanes 17 can embody other structures, mechanisms and devices sufficient to distribute salt falling onto the spinner 16 onto a roadway.

Referring now to FIGS. 1-4, the hydraulic motor 12 includes a motor housing 18, an inlet hydraulic fluid port 20a, an outlet hydraulic fluid port 20b, an inlet hydraulic fluid hose 22a, an outlet hydraulic fluid hose 22b, a motor shaft 24 configured for rotation, a motor shaft seal 26 and a mounting surface 28. The inlet hydraulic fluid hose 22a is fluidly connected to the inlet hydraulic fluid port 20a and is configured as a conduct for pressurized hydraulic fluid entering the motor housing 18. The outlet hydraulic fluid hose 22b is fluidly connected to the outlet hydraulic fluid port 20b and is configured as a conduct for pressurized hydraulic fluid exiting the motor housing 18. As is known in the art, within the motor housing 18, the pressurized hydraulic fluid causes the motor shaft 24 to rotate through engagement with structures (not shown) connected to the motor shaft 24.

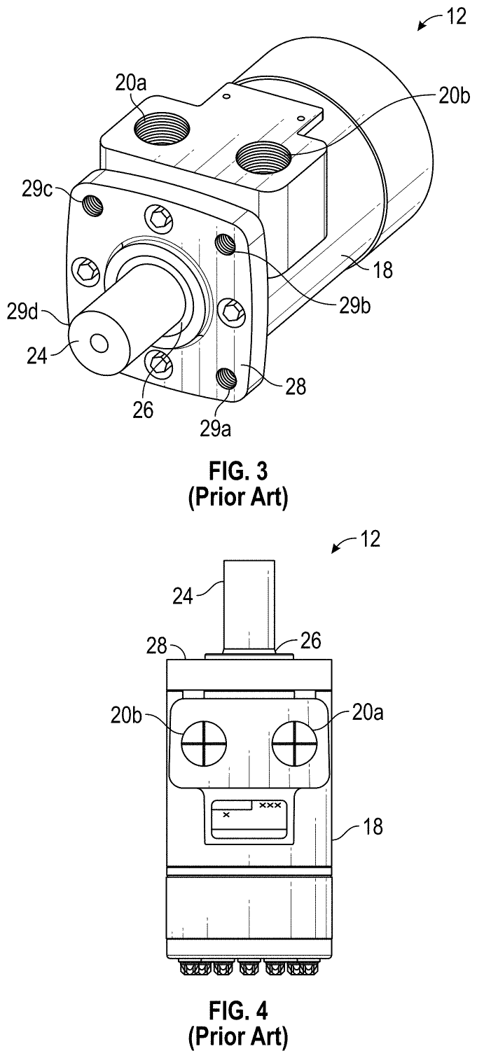

Referring now to FIGS. 3 and 4, the motor shaft seal 26 is conventional in the art and is configured to prevent hydraulic fluid from exiting the motor housing 18 and is further configured to prevent external elements from entering the internal portions of the motor housing 18.

Referring again to FIGS. 3 and 4, the mounting surface 28 includes a plurality of threaded mounting apertures 29a-29d. The threaded mounting apertures 29a-29d are configured to receive mounting hardware (not shown for purposes of clarity) in a manner such that the mounting surface 28 seats against and is connected to the framework 14 thereby securing the hydraulic motor 12 to the framework 14.

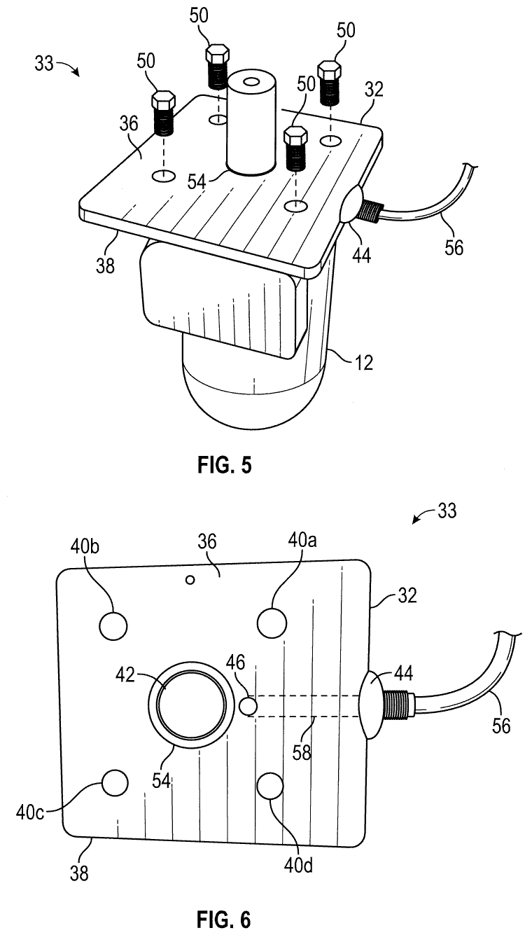

Referring now to FIGS. 3, 5 and 6, the hydraulic motor 12 is fitted with a seal plate 32. The seal plate 32 forms a portion of a novel hydraulic motor shaft seal assembly 33 (hereafter “seal assembly”). In general, the seal assembly 33 is attached to the mounting surface 28 of the hydraulic motor 12 and is configured to assist the motor shaft seal 26 in preventing external elements from entering the internal portions of the motor housing 18 through the motor shaft seal 26. By preventing external elements from entering the internal portions of the motor housing 18, the seal assembly 33 advantageously helps prevent corrosion of the motor shaft.

Referring now to FIG. 6, the seal plate 32 of the seal assembly 33 is illustrated. The seal plate 32 includes an exterior surface 36, an opposing interior surface 38, a plurality of spaced apart clearance apertures 40a-40d, a seal aperture 42, an inlet port 44 and an outlet port 46.

Referring now to FIGS. 3 and 6, the interior surface 38 of the seal plate 32 has a flat configuration such as to seat against the mounting surface 28 of the hydraulic motor 12. In the illustrated embodiment, the opposing exterior and interior surfaces 36, 38 of the seal plate 32 have a substantially parallel orientation, although in other embodiments, the opposing exterior and interior surfaces 36, 38 of the seal plate 32 can have substantially non-parallel orientations.

Referring now to FIGS. 3 and 6, the spaced apart clearance apertures 40a-40d of the seal plate 32 are configured to align with the threaded mounting apertures 29a-29d positioned in the mounting surface 28 of the hydraulic motor 12.

Referring now to FIGS. 3, 5 and 8, the seal plate 32 is secured to the hydraulic motor 12 with a plurality of mounting fasteners 50 extending through the clearance apertures 40a-40d in the seal plate 32, through aligned apertures in the framework 14 and into the threaded mounting apertures 29a-29d positioned in the mounting surface 28 of the hydraulic motor 12. In this manner, the seal plate 32 is positioned on one side of the framework 14 and the hydraulic motor 12 is positioned on an opposite side of the framework 14. However, it should be appreciated that in other embodiments, the relative positioning of the seal plate 32, framework 14 and hydraulic motor 12 can be different. In the illustrated embodiment, the mounting fasteners 50 have the form of hex head machine bolts. However, in other embodiments, the mounting fasteners 50 can have other forms. It should also be appreciated that in still other embodiments, the seal plate 32 can be secured to the hydraulic motor 12 with other structures, mechanisms and devices including the non-limiting examples of clips and clamps.

Referring again to FIG. 6, the seal aperture 42 is configured to receive an optional auxiliary shaft seal 54. The optional auxiliary shaft seal 54 will be discussed in more detail below.

Referring again to FIG. 6, the inlet port 44 is configured to receive a supply of a flexible sealing compound though an optional supply hose 56. In the illustrated embodiment, the flexible sealing compound has the form of grease. However, in other embodiments, the flexible sealing compound can have other forms, such as the non-limiting example of gelled silicon. The term “port”, as used herein, is defined to mean any structure providing a passage for the intake of a fluid or material. Non-limiting examples of a port include a grease fitting, a grease nipple, a Zerk fitting or an Alemite fitting.

Referring again to FIG. 6, the seal plate 32 includes a first internal passage 58 extending from the inlet port 44 to the outlet port 46. The first internal passage 58 facilitates fluid communication between the inlet port 44 and the outlet port 46 and between the inlet port 44 and a plurality of annular cavities. The outlet port 46 and the plurality of annular cavities will be discussed in more detail below.

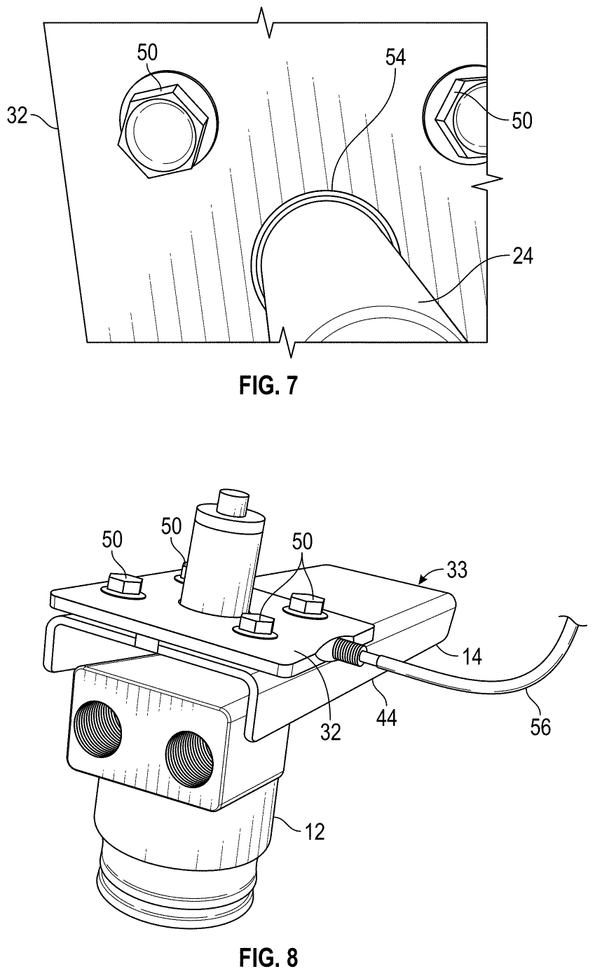

Referring now to FIG. 7, the optional auxiliary shaft seal 54 is configured to circumferentially encase the motor shaft 24 in a manner that substantially prevents external elements from traveling down the motor shaft 24 and entering the internal portions of the motor housing through the motor shaft seal.

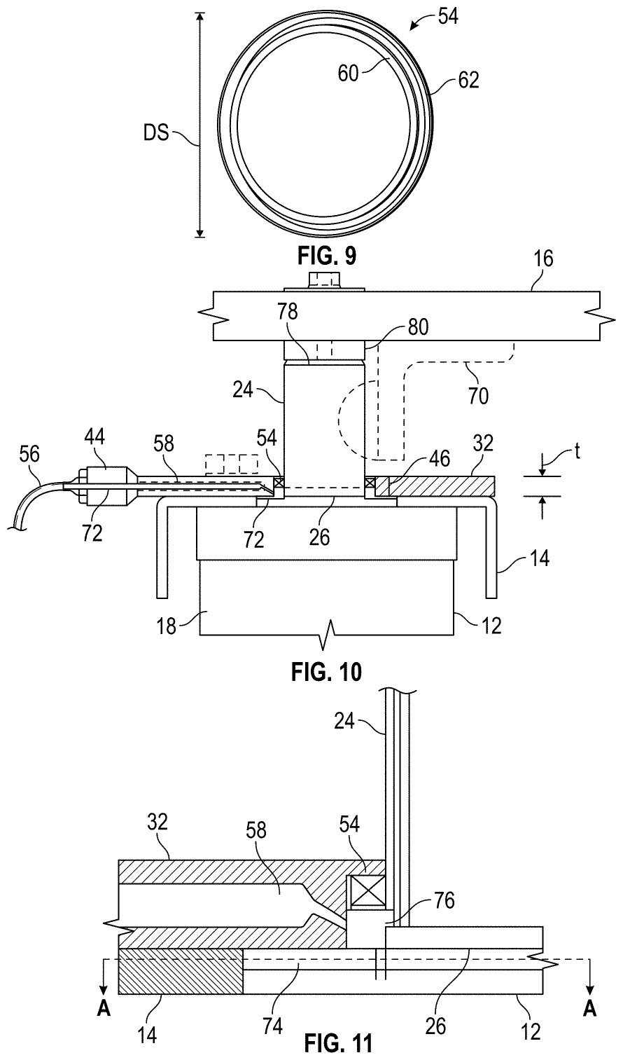

Referring now to FIG. 9, the auxiliary shaft seal 54 is illustrated. In the illustrated embodiment, the auxiliary shaft seal 54 includes an annular lip 60 extending in a radially inward direction from an annular shell 62. The annular lip 60 is configured for contact with the motor shaft and is further configured to substantially prevent external elements from entering the internal portions of the motor housing through the motor shaft seal as the motor shaft rotates. In the illustrated embodiment, the annular lip 60 is formed from a polymeric material, such as the non-limiting examples of a fluoroelastomer material (FKM), an alkyl acrylate copolymer material (ACM), a nitrile butadiene rubber material (NBR), an ethylene acrylic rubber material (AEM) and the like. However, in other embodiments, the annular lip 60 of the auxiliary shaft seal 54 can be formed from other materials sufficient to substantially prevent external elements from entering the internal portions of the motor housing through the motor shaft seal.

Referring now to FIGS. 6 and 9, the annular shell 62 is configured to support the annular lip 60. The annular shell 62 has a circular cross-sectional shape and a diameter DS that approximates a diameter of the seal aperture 42. In operation, an outer surface of the annular shell 62 forms an interference fit with an inner surface of the seal aperture 42. However, it should be appreciated the annular shell 62 of the auxiliary shaft seal 54 can be secured to the seal aperture 42 in other desired manners.

Referring now to FIG. 10, a cross-sectional view of the hydraulic motor 12, framework 14, portions of the spinner 16 and a spinner mounting flange 70, motor shaft 24, motor shaft seal 26, seal plate 32, inlet port 44, first internal passage 58 and auxiliary shaft seal 54 are illustrated. The auxiliary shaft seal 54 is in circumferential contact with the motor shaft 24, thereby advantageously and substantially preventing external elements from entering the internal portions of the motor housing 18 through the motor shaft seal 26.

Referring now to FIGS. 10 and 11, a cross-sectional view of a portion of the framework 14, motor shaft 24, motor shaft seal 26, seal plate 32, first internal passage 58 and auxiliary shaft seal 54 are illustrated. In the illustrated embodiment, the motor shaft 24, motor shaft seal 26, seal plate 32 and auxiliary shaft seal 54 cooperate to form a first annular cavity 74 and a second annular cavity 76. The first annular cavity 74 is in fluid communication with the second annular cavity 76 and the second annular cavity 76 is in fluid communication with the first internal passage 58 in a manner such that a supply of pressurized, flexible, sealing compound flowing through the first internal passage 58 flows into the first and second annular cavities 74, 76.

Referring again to FIG. 11, the first annular cavity 74 is centered about longitudinal axis A-A and abuts a longitudinal portion of the shaft seal 26. The second annular cavity 76 has a generally square cross-sectional shape and abuts the auxiliary shaft seal 54.

Referring now to FIGS. 10 and 11, in operation, the motor shaft 24 rotates as driven by the hydraulic motor 12. The motor shaft seal 26 seals the motor shaft 24 as described above. The auxiliary shaft seal 54 is in circumferential contact with the motor shaft 24 and provides the additional sealing functions described above. The optional supply hose 56 is connected to the port 44 and is configured to provide a pressurized supply of flexible sealing compound (not shown) to the port 44. The flexible sealing compound flows through the port 44, through the first internal passage 58 and into the first and second annular cavities 74, 76. When positioned in the first and second annular cavities 74, 76 the pressurized, flexible, sealing compound contacts the motor shaft 24 and covers the shaft seal 26, and is configured as an additional barrier to prevent external elements from entering the internal portions of the motor housing 18 through the motor shaft seal 26.

Referring again to FIGS. 10 and 11, as the pressurized, flexible sealing compound flows into the first and second annular cavities 74, 76, any excess of the pressurized, flexible sealing compound is relieved through the outlet port 46, which is in fluid communication with the second annular cavity 76. In this manner, advantageously the flexible sealing compound can maintain a beneficial working pressure against the motor shaft 24.

Referring now to FIG. 10, the seal plate 32 has a thickness t. The addition of the thickness t of the seal plate 32 displaces an outboard end 78 of the motor shaft 24 an equal distance t from engagement with the spinner 16. In the instance that the thickness/distance t becomes large enough that engagement of the motor shaft 24 with the spinner 16 is ineffective, then a motor shaft spacer 80 can be added to the outboard end 78 of the motor shaft 24 to maintain sufficient engagement of the motor shaft 24 with the spinner 16. However, it should be appreciated that the hydraulic motor shaft seal assembly can be successfully practiced without the motor shaft spacer 80.

While the hydraulic motor shaft seal assembly 33 illustrated in FIG. 8 has been described above as being seated against an outer surface of the framework 14 supporting the hydraulic motor 12, it is contemplated that in other embodiments the hydraulic motor shaft seal assembly 33 can be positioned between hydraulic motor 12 and the framework 14.

While the hydraulic motor shaft seal assembly has been described above in the context of a salt truck employing a hydraulic motor, it is within the contemplation of the invention that the hydraulic motor shaft seal assembly can be used on any rotating shaft, employed by any motor, engine, structure, assembly or mechanism.

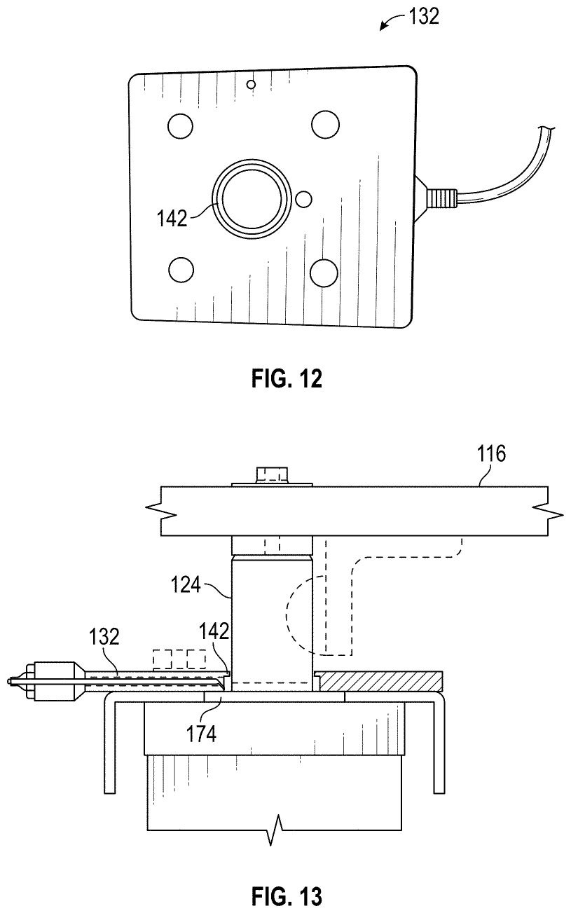

While the hydraulic motor shaft seal assembly has been described above as having the auxiliary shaft seal 54, it is contemplated that in certain embodiments the hydraulic motor shaft seal assembly can be practiced without the auxiliary shaft seal 54. Referring now to FIGS. 12 and 13, a second embodiment of a seal plate 132 is illustrated. The seal plate 132 is the same as the seal plate 32 shown in FIG. 6 and described above with two exceptions. First, the seal plate 132 does not incorporate an auxiliary shaft seal 54. Second, a seal aperture 142 of the seal plate 132 forms a tight circumferential tolerance with a motor shaft 124 extending therethrough. The tight circumferential tolerance formed between the motor shaft 124 and the seal aperture 142 precludes the formation of a second annular cavity. In this scenario, the pressurized, flexible sealing compound positioned in a first annular cavity 174 may seep into a small gap formed by the tight tolerance between the motor shaft 124 and the seal plate 132.

The principle and mode of operation of the hydraulic motor shaft seal assembly has been described in certain embodiments. However, it should be noted that the hydraulic motor shaft seal assembly may be practiced otherwise than as specifically illustrated and described without departing from its scope.

What is claimed is:

1. A motor shaft seal assembly configured to prevent external elements from entering internal portions of a motor housing of a motor through a motor shaft seal, the motor shaft seal assembly comprising:
a seal plate configured to mount to a motor, the seal plate having a seal aperture configured to encircle a motor shaft of the motor;
an inlet port mounted to the seal plate;
an internal passage extending from the inlet port, through the seal plate, to a plurality of annular cavities positioned proximate the motor shaft; and
a supply of a flexible sealing compound provided to the plurality of annular cavities in a manner such as to contact the motor shaft, thereby forming an additional barrier to prevent external elements from entering internal portions of the motor through the motor shaft seal.

2. The motor shaft seal assembly of claim 1, wherein the motor is a hydraulic motor.

3. The motor shaft seal assembly of claim 1, wherein a shaft seal is mounted in the seal aperture of the seal plate and configured to circumferentially engage a motor shaft of the motor.

4. The motor shaft seal assembly of claim 3, wherein the shaft seal includes an annular lip configured to engage the motor shaft as the motor shaft rotates.

5. The motor shaft seal assembly of claim 3, wherein the shaft seal cooperates with the motor shaft, the seal plate, the motor and a framework to form the plurality of annular cavities.

6. The motor shaft seal assembly of claim 5, wherein each of the annular cavities is in fluid communication with each other.

7. The motor shaft seal assembly of claim 1, wherein the seal plate includes an outlet port configured to relieve excess pressure in the flexible sealing compound.

8. The motor shaft seal assembly of claim 7, wherein the outlet port is in fluid communication with the plurality of annular cavities.

9. The motor shaft seal assembly of claim 1, wherein the flexible sealing compound covers the motor shaft seal.

10. The motor shaft seal assembly of claim 1, wherein the flexible sealing compound has the form of grease.

11. A method of preventing external elements from entering internal portions of a motor housing of a motor through a motor shaft seal, the method comprising the steps of:
mounting a seal plate to a motor, the seal plate having a seal aperture configured to encircle a motor shaft of the motor;
mounting an inlet port to the seal plate;
forming an internal passage within the seal plate, extending the internal passage from the inlet port, through the seal plate, to a plurality of annular cavities positioned proximate the motor shaft;
supplying a flexible sealing compound to the plurality of annular cavities in a manner such as to contact the motor shaft, thereby forming an additional barrier to prevent external elements from entering internal portions of the motor through the motor shaft seal.

12. The method of claim 11, wherein the motor is a hydraulic motor.

13. The method of claim 11, including the steps of mounting a shaft seal in the seal aperture of the seal plate and engaging the motor shaft of the hydraulic motor with the shaft seal.

14. The method of claim 13, including the step of engaging the motor shaft with an annular lip of the shaft seal as the motor shaft rotates.

15. The method of claim 11, including the step of bounding the plurality of annular cavities with a combination of the motor shaft, the seal plate, the hydraulic motor and a framework.

16. The method of claim 11, including the step of forming the annular cavities to be in fluid communication with each other.

17. The method of claim 11, including the step of relieving excess pressure in the flexible sealing compound with an outlet port.

18. The method of claim 17, including the step of arranging the outlet port to be in fluid communication with the plurality of annular cavities.

19. The method of claim 11, including the step of covering the motor shaft seal with the flexible sealing compound.

20. The method of claim 11, including the step of forming the flexible sealing compound from of grease.
